(19) United States
(12) Patent Application Publication
(10) Pub. No.: US 2017/0027141 A1
(43) Pub. Date: Feb. 2, 2017

(54) Organism Immobilization Apparatus

(71) Applicant: Smith Root, Vancouver, WA (US)

(72) Inventor: Lee Carstensen, Vancouver, WA (US)

(21) Appl. No.: 15/224,638

(22) Filed: Jul. 31, 2016

Related U.S. Application Data
(60) Provisional application No. 62/199,966, filed on Jul. 31, 2015.

(51) Int. Cl. A01K 79/02; A01K 61/00

(52) U.S. Cl. CPC A01K 79/02; A01K 61/001

(57) ABSTRACT

A device for handling and affecting a physiological state of an aquatic species with a pair of gloves, a multiplicity of electrodes, and a pulsator attached to the electrodes, so that when the pulsator is activated the current, alters the physiological state of the aquatic species.

### RELATED APPLICATIONS

This application claims the benefit of U.S. provisional application No. 62/199,966, filed on Jul. 31, 2015, (Docket No. SRI 2.023.CIP.PR), the contents herein incorporated into this application by reference.

### BACKGROUND

The present inventive subject matter relates to the systems and methods for the handling of aquatic species using electric currents and gloves.

The effects of electric currents on fish are well known in the prior art and especially in the general techniques of electrofishing. Electrofishing involves the use of electric currents to attract and/or repel fish with the intent of creating aquatic barriers, sample fish barriers, and/or to increase collection yields.

It has been established that relatively small potentials that are impressed across the body of a fish invoke a flight reaction. Larger potentials result in the alignment of the fish with the electric current, or electrotaxis, Still larger potentials may result in unconsciousness or complete euthanasia of the fish.

Electrofishing has traditionally been used in freshwater lakes and streams and is the subject of U.S. Pat. Nos. 5,445,111; 5,327,854; 4,750,451; 4,672,967; 4,713,315; 5,111,379; 5,233,782; 5,270,912; 5,305,711; 5,311,694; 5,327,668; 5,341,764; 5,551,377; and 6,978,734 which are incorporated herein by reference.

A recurring problem with the examination of laboratory fish is that they tend to be very active. The small size of the fish combined with their activity can impair the researcher from making precise scientific measurements unless the fish is caught and inspected. Thus direct examination of fishes is preferred to “in situ” measurements.

An aspect of fish conservation involves the collection, tagging, and then the subsequent release of tagged fish. If the tagged fish is then captured at a later date, the difference in the fishes' location, health, and size can be compared to when the fish was first caught. Alternately, a group of fish may be caught from a particular area to determine the statistical distribution of each of the fish species. Furthermore, fishes may be caught to determine if a fish is from wild stock or from fishery stock. In all of these cases, when the fish are captured they are typically placed in a holding tank on the boat, and then they are inspected for species and/or tag information, and then returned to the water. At other times, fish may be taken back to a laboratory ashore for further examination. The agitated state of the fish, both in the boat and in the laboratory, will typically make it difficult for fish scientists to handle the fish.

What is desired is a safe and portable method for anesthetizing fish to minimize stress on the fish while scientists are handling and inspecting them. Prior art solutions and techniques to induce anesthesia in fish involve the addition of chemicals to the tank. See U.S. Pat. Nos. 3,551,566; 3,644,625; and 4,807,615; which are incorporated by reference. Chemicals used for anesthesia are expensive to acquire, pose a storage and maintenance problem, and are at risk of degradation. Prior art solutions and techniques to induce anesthesia in fish without the addition of chemicals to the tank involve a safe way to anesthetizing fish in the holding tank of a boat. See U.S. Pat. No. 8,087,384; which is incorporated by reference. This system requires installation and use of equipment onboard a boat.

Therefore, what is desired is an apparatus to immobilize fish and place the fish in an anesthesia state while in a laboratory setting. It is also desired that the apparatus pose little or no attendant risk to any of the researchers whom are close to the holding tank. It is also desired that this apparatus can operate without significant modification to the laboratory infrastructure. It is also desired that this apparatus operate without the use of chemical additives.

### SUMMARY

The present inventive subject matter overcomes problems in the prior art by providing for systems and methods for an apparatus to handle and affect the physiological state of an aquatic species, said apparatus having a pair of gloves, a multiplicity of electrodes, said electrodes attached to each glove; a pulsator, said pulsator attached to the electrodes; such that when the pulsator is activated, and the aquatic species is handled by the gloves, the current passing from one electrode to another, alters the physiological state of the aquatic species.

Another example of the inventive subject matter is a method for the handling and affecting the physiological state of an aquatic species, said method comprising the steps of handling the aquatic species with a pair of gloves, wherein said gloves further comprise a multiplicity of electrodes, wherein said electrodes are attached to each glove, and a pulsator, said pulsator attached to the electrodes; connecting the gloves to a pulsator, activating the pulsator, such that when the pulsator is activated, the physiological state of the aquatic species is affected.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a front view of the pair of gloves with the embodiment of the inventive subject matter.

FIG. 2 is a view of the gloves with the inventive subject matter connected to a pulsator.

FIG. 3 is system diagram of the inventive subject matter.

FIG. 4 is close in view of a glove with an electrode and a switch mounted to the glove.

FIG. 5 is a diagram of the glove being used in connection with fish processing.

FIG. 6 is a diagram of the glove being used on an electrofishing boat.

FIGS. 7A-7D is an alternate embodiment of the gloves with conductive material/electrodes being placed on various places on the gloves.

FIG. 8 is a view of the inventive subject matter used proximate to a holding tank.

FIG. 9A-9C is a schematic of an alternate embodiment for a constant current pulsator.

FIG. 10A-10B is a block diagram of the alternate embodiment.

FIG. 11 is an image of the alternate embodiment

### DETAILED DESCRIPTION

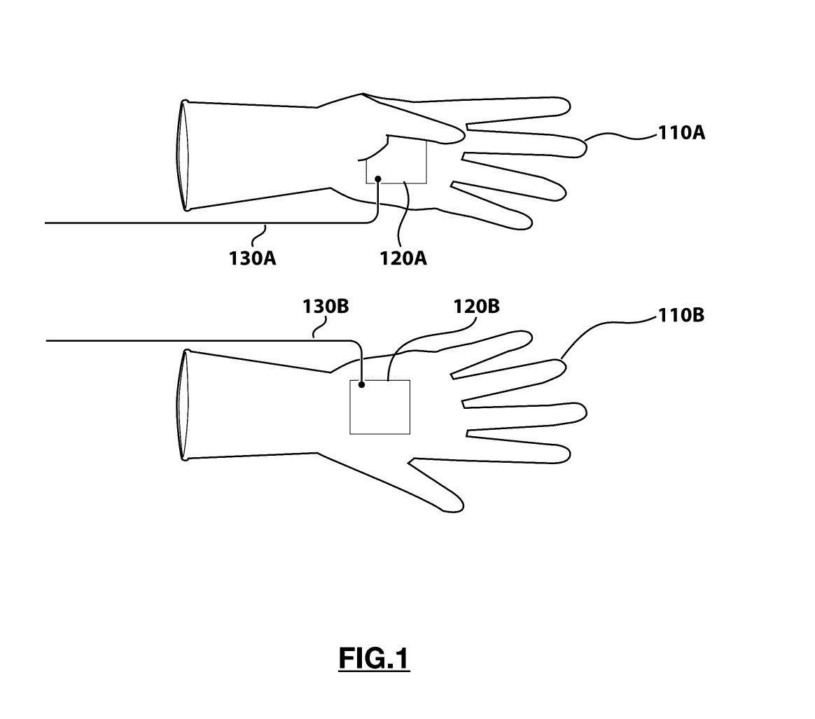

Representative embodiments according to the inventive subject matter are shown in FIGS. 1-10 wherein similar features share common reference numerals.

Now referring to FIG. 1 which depicts the inventive subject matter of the gloves 110A, 110B, attached to the gloves are conductive materials/electrodes 120A, 120B, which are attached by wires 130A, 130B to an electric power source (not shown). The gloves 110A, 110B would typically be impermeable, non-conducting, water resistant gloves that are well known in the arts. Such gloves may be made from plant materials, such as rubber gloves; the gloves may also be made from animal products, such as deer and/or cow, and sealed to prevent permeation of water; or the gloves may also be made from a synthetic material, such as, synthetic rubber, and/or polyethylene. The gloves should be thick enough to prevent any chance of conductivity. The electrodes attached to the glove can be made from any number of conductive materials, such as, aluminum, copper, silver, gold, or alloys of other metals with the aforementioned conductive materials. The conductive materials can be infused into a top layer of the glove or the conductive material may be attached separated in the form of a strap or tape. The important aspect of the conductive material is that it will move in concert with the palm and/or fingers of the glove so that when an object is gripped the conductive material will come into contact with the gripped object.

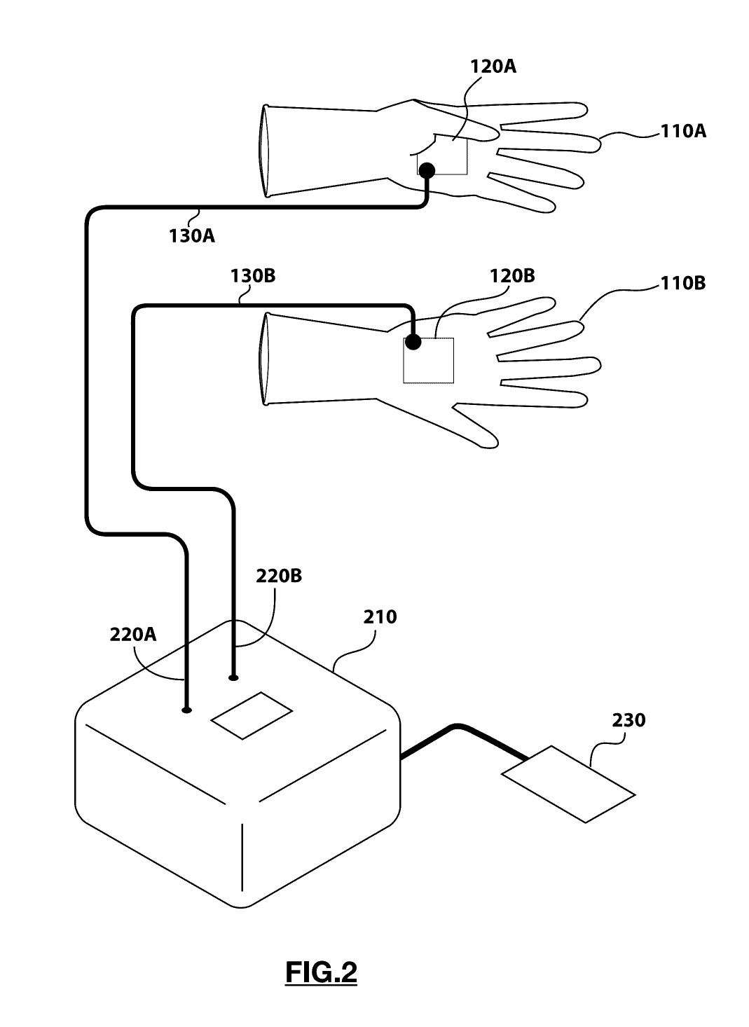

Now referring to FIG. 2 which shows the gloves 110A, 110B, the gloves 110A, 110B are connected to the conductive materials/electrodes 120A, 120B, which are connected by wires 130A, 130B to the electrical terminals 220A, 220B of a pulsator 210. The pulsator 210 is operated by a switch 230, so that the conductive materials/electrodes 120A, 120B are energized when the switch is closed 230. The voltage and current passing through the wires 130A, 130B is dependent on the settings of the pulsator 210 and the object held between the conductive materials/electrodes 120A, 120B.

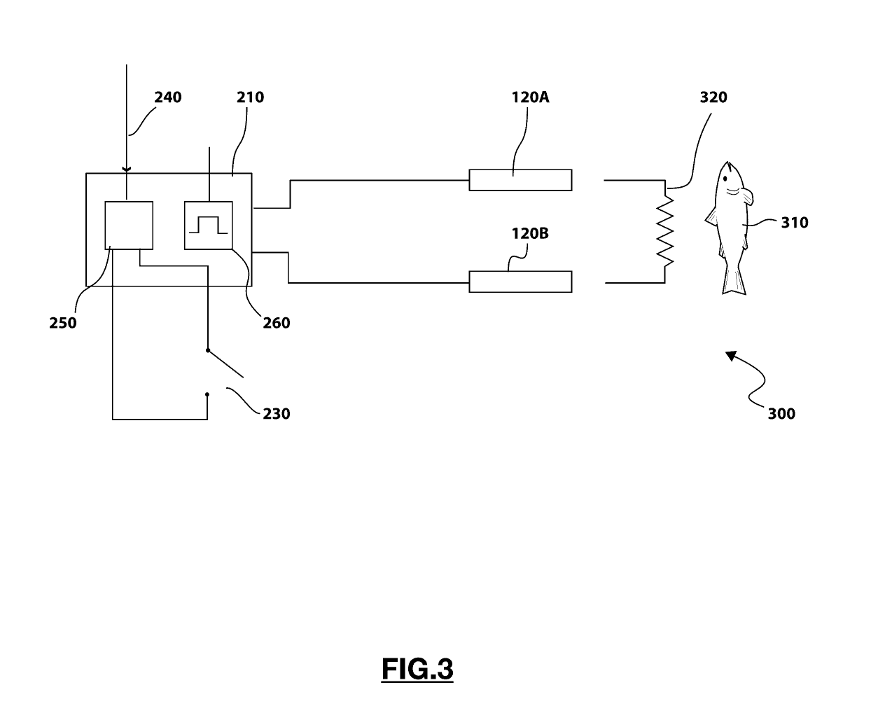

Now referring to FIG. 3 which illustrates a schematic of the aforementioned FIGS. 1 and 2. In FIG. 3, the conductive materials/electrodes 120A, 120B are typically placed proximate to and in a conductive media (e.g. freshwater or saltwater) that surrounds a fish 310. The term “fish” not being limited to the small class of fish-like species, rather all aquatic animals that are confined in a liquid solution, typically being freshwater, saltwater, and/or brackish water. The electrical current flows from one side of the conductive material/electrode 120A and through the fish 310 to the other conductive material/electrode 120B.

The current passing through the fish causes a physiological reaction that ranges from flight (small potential differences) to death (large potential differences). Intermediate states include electrotaxis (movement of the fish from the cathode to the anode) to electronarcosis (stunning of the fish due to the electrical current). Therefore, in referring back to FIG. 3, in conjunction with FIGS. 1 and 2, that the use of a pulsator 210 with a variable voltage setting 240, a power source 250, an external power switch 230, and a waveform modulator 260 can produce a power source that can immobilize or stun a fish.

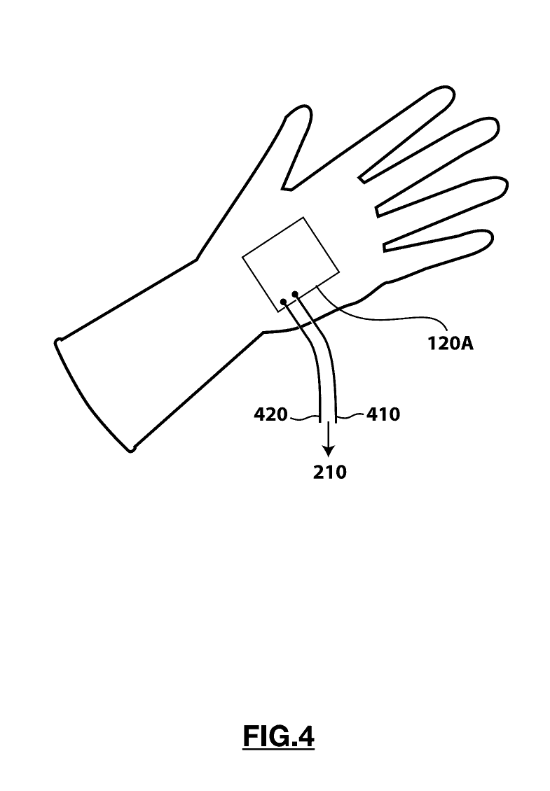

Now referring to FIG. 4 which depicts a variation of the glove and the conductive material/electrode 120A which also incorporates a pressure sensitive switch 410/420. This pressure sensitive switch 410/420 can be used to turn on/turn off the application of voltage from the pulsator 210. In these circumstances the voltage will only be applied when the glove grasps a fish. This “glove switch” can be used in the conjunction with an external power switch so that a fish can be grasped with no electricity applied, then the external power switch used to apply electricity to the fish.

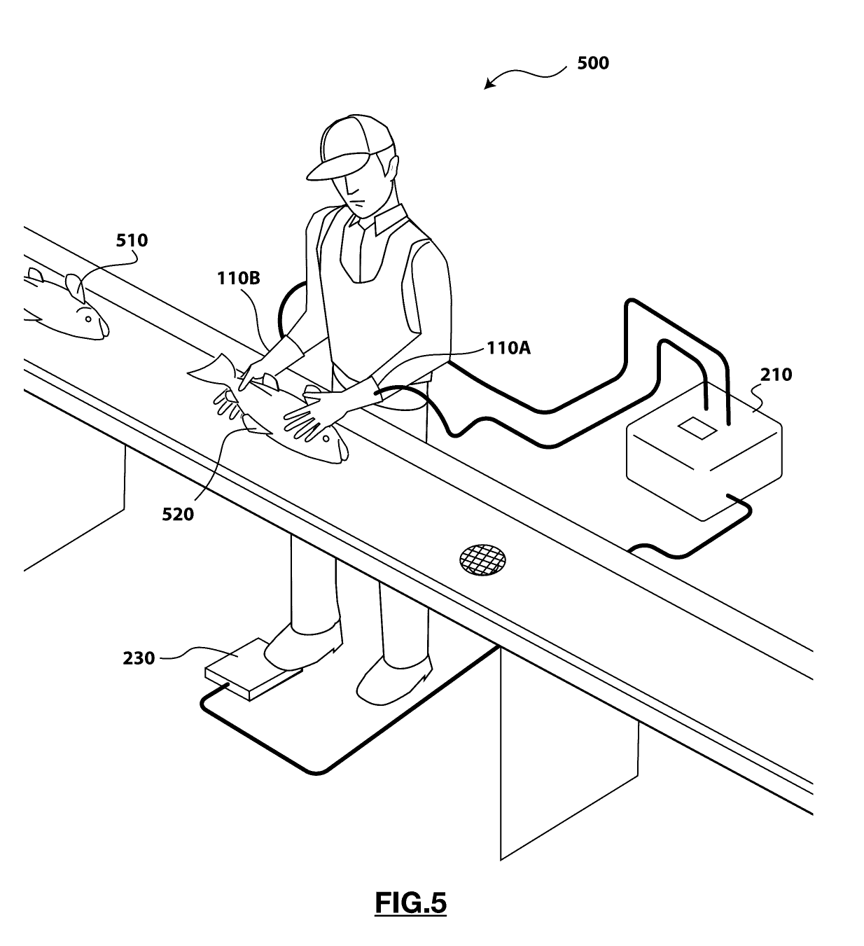

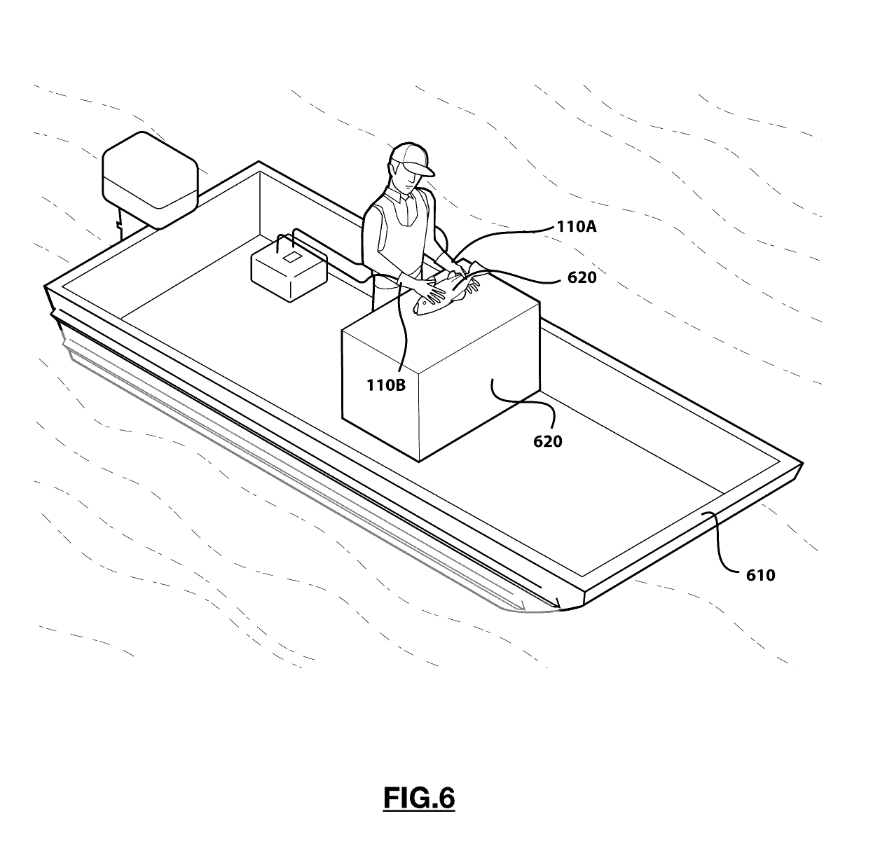

Now referring to FIG. 5 which shows the use of the inventive subject matter in a fish processing application. The fish 510 are transported down a conveyor 520 and grasped by the gloves 110A, 110B. The external power switch 230 is used to activate the pulsator 210, so that current passes through the gloves 110A, 110B and through the fish 510. Now referring to FIG. 6 which illustrates the use of the gloves 110A, 110B which pass current through a fish on a platform 620 mounted on a boat 610.

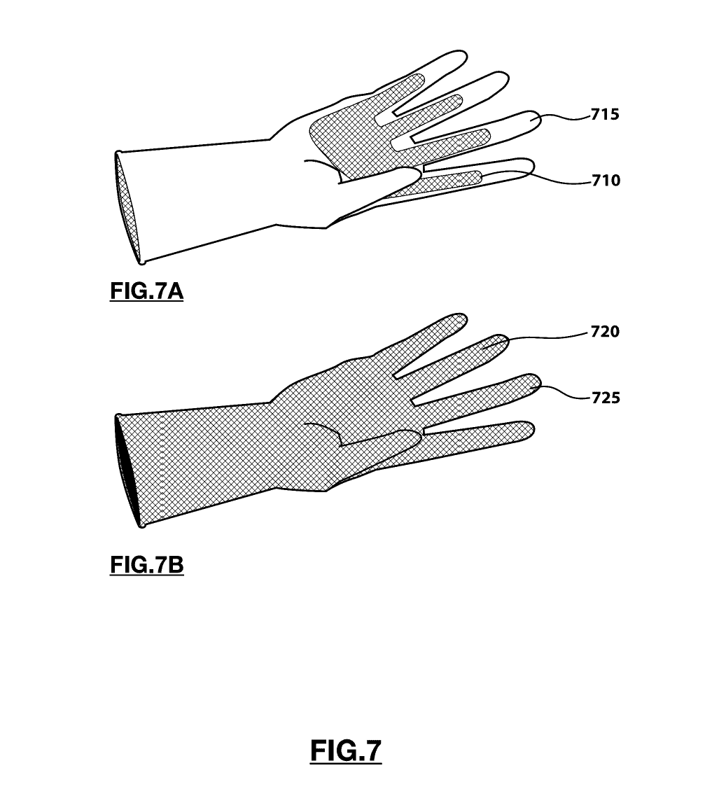

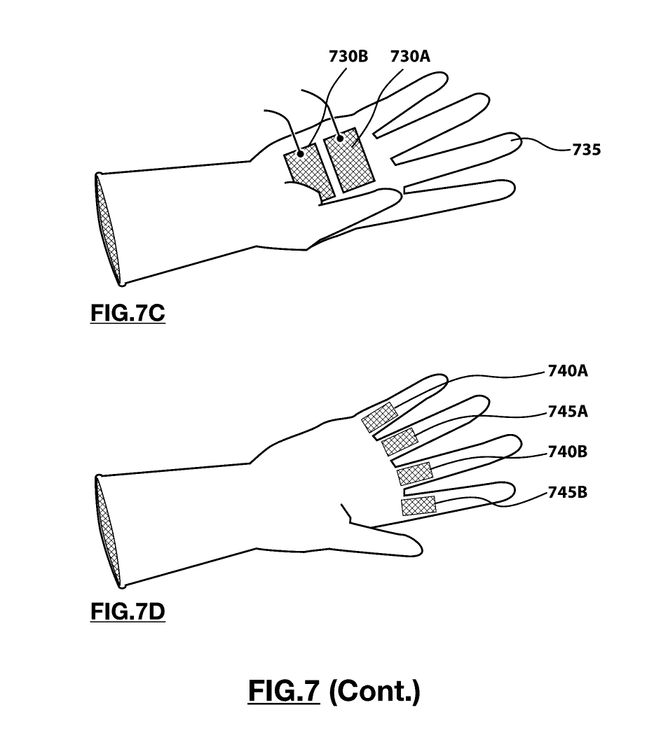

Now referring to FIGS. 7A-7D, which illustrates different embodiments of the conductive material on the gloves. For example, FIG. 7A shows the conductive material being on the palm and also applied to a finger 715. FIG. 7B shows the conductive material being applied to the entire glove including the fingers. FIG. 7C illustrates the placement of opposite polarity electrodes 730A, 730B on the palm of the hand. FIG. 7D depicts the use of alternating opposite electrodes on the fingers of the hand. The constant current compensates for differences in contact with the fish by each of the gloves, and also has inherent safety aspects. It is clear to one skilled in the arts that there are many variations of the electrodes that may be employed.

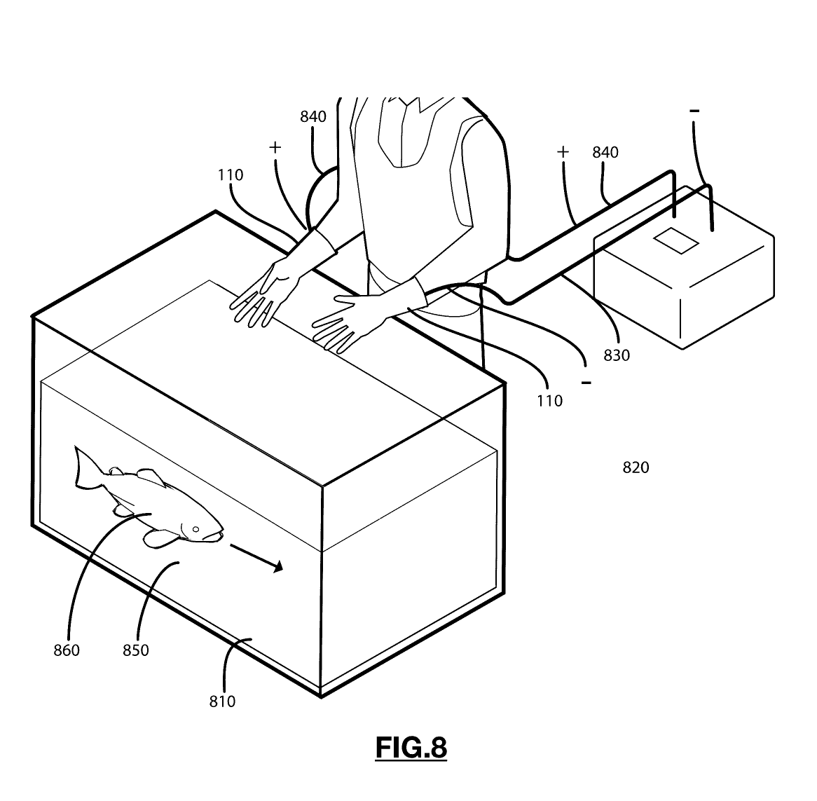

Now referring to FIG. 8 which shows the use gloves connected to a pulsator 210. The pulsator 210 is connected to the gloves 110. The gloves 110 are placed in the water proximate to the fish 850 which causes and electric field 860 to be impressed across the fish 850.

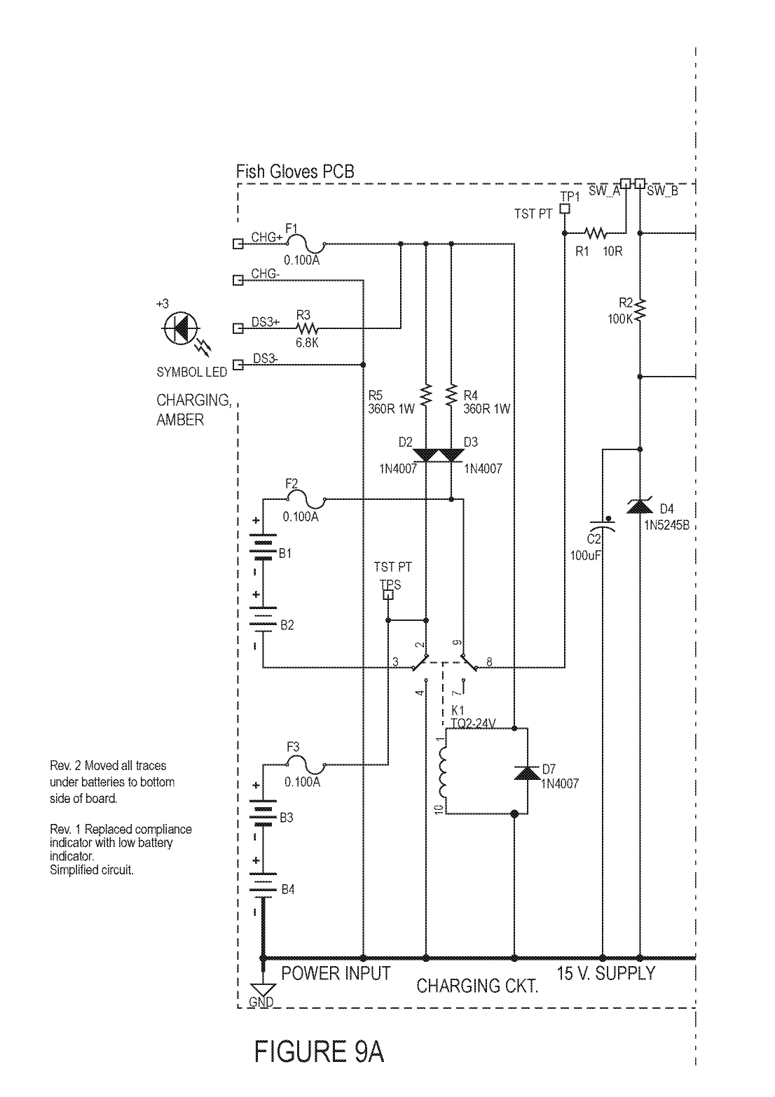

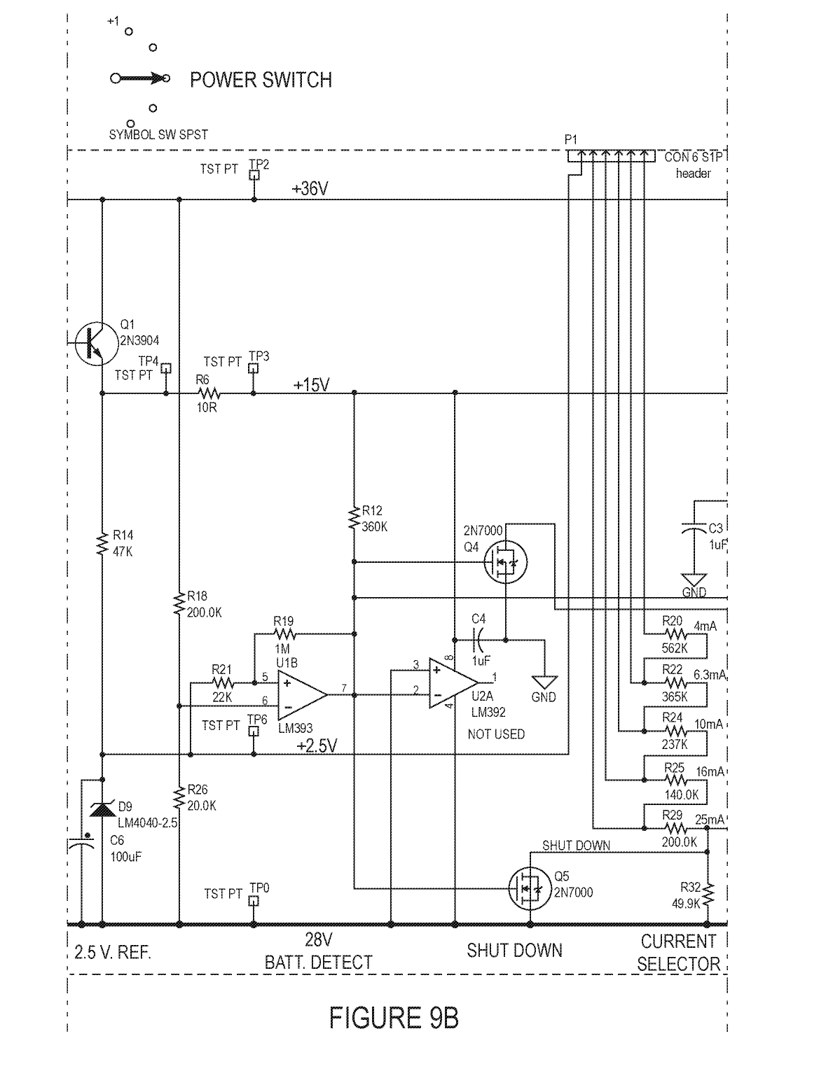

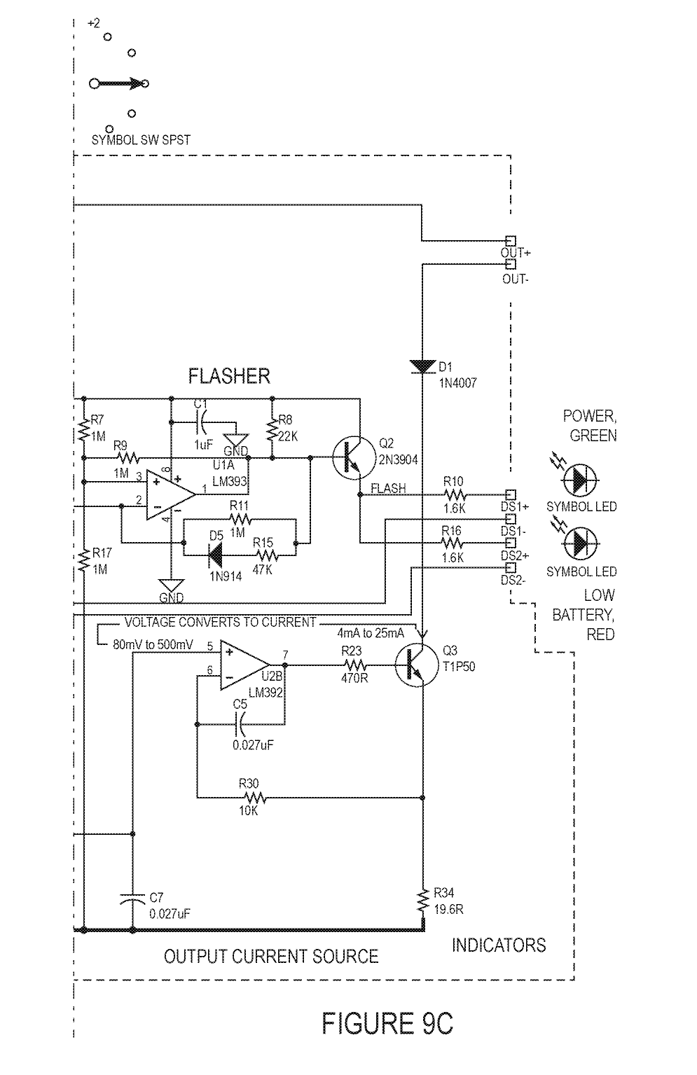

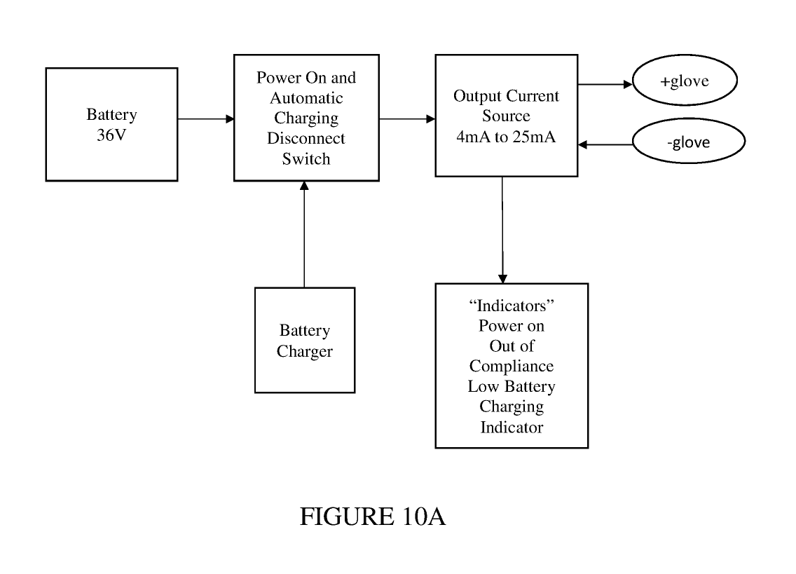

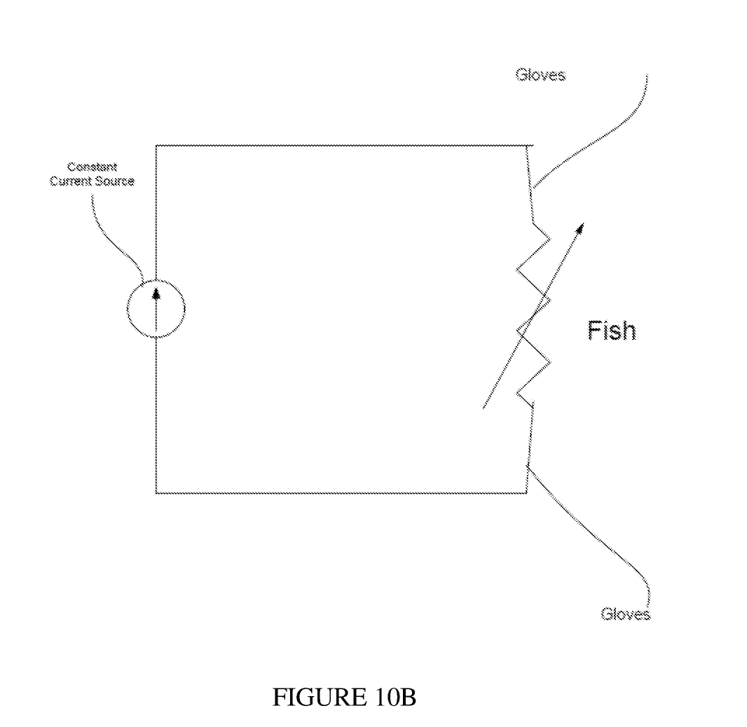

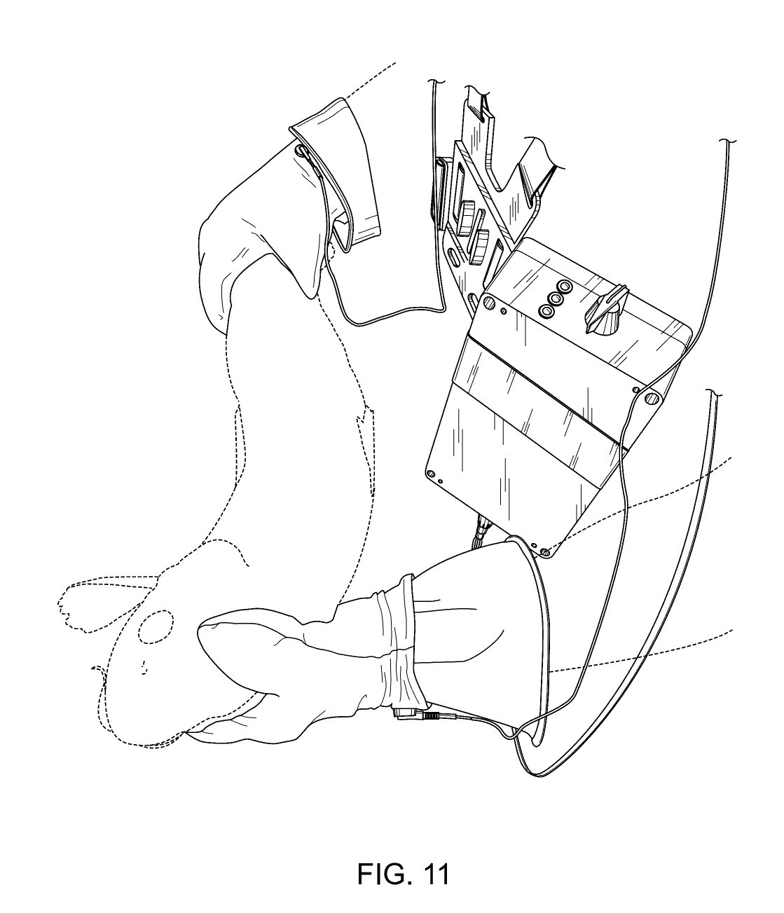

Now referring to FIG. 9A-9C (schematic) and FIG. 10A-10B (block diagram), and FIG. 11, which depicts the alternate embodiment of the constant current electroanesthesia device which provides a constant current across and through the body of the fish. In situations where the fish has lower resistance (higher conductivity), the constant current creates a lower potential difference (E=IR). Where the fish has a higher resistance (lower conductivity), the constant current creates a higher potential difference.

The above described Fish Handling Gloves are lightweight, water-proof, portable and designed to temporarily immobilize live fish for easier handling. These gloves are electrified to pass levels of manually adjustable electric current through the body of a fish. Recovery of motion occurs for the fish upon release.

The equipment consists of a pair of conductive Fish Handling Gloves, a pair of rubber Insulating gloves, control box, wire leads, battery charger and accessories. Rechargeable batteries are contained in the light-weight waterproof control box that can be hooked on a belt or included chest harness, making the device fully portable during the fish handling process.

Two sets of gloves must be worn when operating the Fish Handling Glove system. A pair of rubber Insulating Gloves insulates the handler from the electric current, and is worn under the pair of Fish Handling Gloves. The conductive Fish Handling Gloves are worn over the rubber gloves and are connected to the Control Box with the Wire Leads. On one hand, a Fish Handling Glove acts as the negative terminal (cathode) and on the other hand the glove is the positive terminal (anode). The circuit is completed and current will flow when an electric current setting is selected and a fish is contacted by each of the Fish Handling Gloves. A pair of typical fish handling gloves would have the following technical specifications.

| | |
|---|---|
| Power Source | 9V Rechargeable NiMH, 175 mAh × 4 |
| Battery Voltage, | 32 V min to 39 V max |
| normal operation | |
| Battery | 30 V typical, ±2% range |
| Shutdown | |
| Voltage | |
| Estimated | 25 mA range: 5 hours |
| Battery | 16 mA range: 9 hours |
| Life | 10 mA range: 13 hours |
| | 6.3 mA range: 18 hours |
| | 4 mA range: 25 hours |
| Output Voltage | 39 V maximum |
| Output Current | 25 mA maximum |
| Environmental | Storage temperature: −20° to 30° C. |
| Requirements | |
| Size and Weight | Height: 8.25 in; Width: 4.75 in; Depth 2.5 in; |
| | Weight: 1.55 lb |

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

We claim:

1. An apparatus for handling and affecting a physiological state of an aquatic species, said apparatus comprising:
a pair of gloves, said glove having an opening through which a user's hand extends for gripping the aquatic species;
a multiplicity of electrodes, said electrodes attached to each glove;
a pulsator, said pulsator attached to the electrodes;
such that when the pulsator is activated by a switch, and the aquatic species is gripped by the user through the gloves, the current passing from one electrode to another, alters the physiological state of the aquatic species.

2. The apparatus as described in claim 1 wherein the electrodes attached to each glove move in concert with the user's hand movement so that the aquatic species gripped by the gloves will come in contact with the electrodes.

3. The apparatus as described in claim 1 used in handling aquatic species surrounded by a conductive media.

4. The apparatus as described in claim 1 further including a pressure sensitive switch in conjunction with an external switch.

5. The apparatus as described in claim 1 wherein the physiological state is selected form a group consisting of flight, electrotaxis, electronarcosis or death.

6. The apparatus as described in claim 1 wherein the electrodes are made by conductive materials selected from a group consisting of aluminum, copper, silver or gold.

7. The apparatus as described in claim 1 wherein the electrodes are directly attached to a top layer of the gloves.

8. The apparatus as described in claim 1 wherein the electrodes are attached to a top layer of the gloves as strap or tape.

9. The apparatus as described in claim 1 wherein the electrodes are attached to a palm area of the gloves.

10. The apparatus as described in claim 1 wherein the electrodes are attached to a finger area of the gloves.

11. The apparatus as described in claim 1 wherein the electrodes are attached to a constant current electroanesthesia device.

12. A portable apparatus for handling and affecting a physiological state of an aquatic species, said apparatus comprising:
a pair of conductive gloves;
a pair of insulating gloves, said pair of insulating gloves worn interior to the pair of conductive;
a anode electrode, said anode electrode attached to a conductive glove;
a cathode electrode, said cathode electrode attached to a conductive glove;
a control box, said control box controlling the input to the gloves
a pair of wire leads, said pair of wire leads connecting the pair of conductive gloves to the control box;
such that when an user wears the conductive gloves over the insulating gloves to both his hands and grips an aquatic species with both the hands a current passing from one electrode to another, alters the
physiological state of the aquatic species.

13. A method for the handling and affecting the physiological state of an aquatic species, said method comprising the steps of:
a glove forming a handle having an opening formed therein through which a user's hand extends for gripping the aquatic species
handling the aquatic species with a pair of gloves, wherein said gloves further comprise a multiplicity of electrodes, wherein said electrodes are attached to each glove, and a pulsator, said pulsator attached to the electrodes;
connecting the gloves to a pulsator,
activating the pulsator,
such that when the pulsator is activated, the physiological state of the aquatic species is affected.
